(19) United States
(12) Patent Application Publication
(10) Pub. No.: US 2022/0270066 A1
(43) Pub. Date: Aug. 25, 2022

(54) SHOPPING AND PURCHASING SYSTEM

(71) Applicant: LaKra Invest GmbH, Frankfurt (DE)

(72) Inventor: Seyad Arash Mousavi Gharavi, Frankfuirt am Main (DE)

(73) Assignee: LaKra Invest GmbH, Frankfurt (DE)

(21) Appl. No.: 17/626,350

(22) PCT Filed: Jul. 13, 2020
(86) PCT No.: PCT/DE2020/100613

§ 371 Date: Jan. 11, 2022

(30) Foreign Application Priority Data
Jul. 11, 2019 (DE) 10 2019 118 883.0
Jan. 24, 2020 (DE) 10 2020 101 673.5

(51) Int. Cl. G06Q 20/20; G06Q 20/18

(52) U.S. Cl. CPC G06Q 20/208; G06Q 20/18; G06Q 20/209; G06Q 20/206

(57) ABSTRACT

Device for use as shopping and payment system for any kind of goods.

The present invention relates to a system and a process for shopping and payment using scanning systems.

Wholesale and retail companies are very interested in efficient and innovative solutions for the checkout at cashier stations. In particular the waiting times at the cashier in wholesale and retail markets should be reduced as same are considered particularly disturbing by customers.

In a typical checkout process in wholesale and retail markets the customer has to place all purchased goods from a shopping cart or a shopping bag onto a cash belt. The cashier subsequently scans the barcode for each single article separately. By virtue of the scanning process, the barcode symbol is decoded, the purchased article is identified and the information related to the purchase price is sent to the cash desk system. For products the price of which depends on the weight, the cashier has to weigh the respective product.

After scanning the barcode the purchase price is calculated and the customer pays for his purchase for which payment usually several different payment methods are available. Thereafter the customer has to pick up the purchased articles and to store same in his shopping bag. This process is laborious and complicated and in particular the need for the cashier to scan each article purchased by the customer separately and, in the case of products the price of which is determined by their individual weight, to weigh the product in addition may need a lot of time. The waiting times at checkout associated with this process cause dissatisfaction on the side of the customer.

To solve these problems processes have been developed in which the customers themselves can scan the articles to be purchased (so called Self-Scanning) which avoids the need for sequential scanning at the cashing station.

A first variant of such systems are self-service terminals. At these terminals a scanner is provided with which the customers may scan the barcode symbols of their goods individually. As the customers, however, usually have less experience with scanning than the cashier, the waiting times with such systems at the check-out are even rather increased which increases the degree of dissatisfaction of the customer.

To avoid the time consuming step of sequential scanning at checkout, systems are known with which the customer themselves scan the purchased article at the point of time where he puts the respective article in his or her shopping basket or the shopping cart. Such systems register the entirety of the articles purchased by the customer and at the checkout only the information relating to the entire content of the purchase has to be forwarded to the cashing system. For this purpose individual cashing stations may be used which usually require a payment by card or the customer uses a regular cashing station with a cashier at which the information concerning the purchased products is forwarded to the cashing station and thereby the purchasing process can be accelerated.

A system as described before which uses regular cashing stations is e.g. known from DE 10 2016 010 199.

In the known systems the problem of registration of loose articles is solved through the use of weighing means which, after weighing, produce a barcode label which contains the information on weight and price of the purchased good in encoded form and which thereafter is registered by the customer with his scanning device. This leads to the problem, however, that additional waiting times may be created if several persons have to weigh loose articles at the same time for price determination.

It was thus an object of the present invention to improve existing systems for purchase and payment known in the art with which loose articles may also be registered without the need for the customer to accept waiting times at the respective weighing stations.

This object is achieved with the a in accordance with claim 1.

Preferred embodiments of the invention are set forth in the dependent claims and the specification hereinafter.

The device in accordance with the present invention for use as shopping and payment system for goods of any kind comprises first means for registering and scanning of barcode-symbols second means for determining and registering the weight of a purchased article third means for decoding the registered barcodes to register the price of the purchased articles in a digital product basket, and fourth means for storing price and, if applicable, number or weight of the individual purchased articles and the entirety of the purchased products.

The first means may be any known device for registering and scanning barcodes which are known to the skilled person and which have been described in great variety in the prior art. Just by way of example, cameras and barcode-scanners may be mentioned here.

With the first means of the device in accordance with the present invention the barcodes affixed to the products are registered. For loose articles the barcode may be scanned which is attached to the shelf of the location where the product is presented. Depending on the type of the product it is also possible to place a respective barcode on the product itself.

The first means apart from the foregoing is not subject to particular limitations.

By way of example, cameras may be mentioned, which can be integrated into the device in accordance with the invention. The placement in respectively at the device in accordance with the invention is not subject to particular limitations.

It should be assured, however, that all goods the purchasing customer wants to buy can be reliably registered with the first means. This ensures that the customer does not carry away from the shop any articles which have not been registered and which, at the end, have not been paid. For the customer this provides safety that he or she forgets to properly register a purchased product and for the shop it provides a safeguard against theft.

In accordance with a preferred embodiment, the device in accordance with the present invention comprises several means to register and scan barcodes, preferably on different sides. Thereby the reliable registration is secured even better.

The second means of the device in accordance with the present invention serves the purpose to register the weight of a purchased article. This enables the customer to also register the individual price of loose articles priced according to weight so that he or she neither has to go to and to use separate weighing stations nor the articles have to be individually weighed at the cashing station in a time consuming manner.

The second means may be any device for mobile weight determination as known from the prior art in great variety and commercially available from multiple manufacturers. Accordingly, it is not necessary to provide further details here.

Prior to or after the registration of the weight the barcode of loose goods is registered by the first means and the registered weight and the information on price per weight (which is obtained from the barcode) are combined in a suitable manner to be able to determine and store the purchase price of the individual purchased products. Thereby a correct calculation of the purchased articles is also possible for loose goods.

The second means for determining and registering a weight present in the device in accordance with the present invention may not only be used for loose goods but also for determination of the weight of all articles. This allows to determine the entire weight of the purchase which provides valuable information to the customer since he can recognize the point at which his purchase may become to heavy to be carried and at which he should consider to make use of auxiliary means providing relief for carrying the purchased goods to his home. Health problems caused by carrying heavy loads may thus be avoided already at the point in time when the goods are placed in the shopping basket or the shopping cart by signaling to the customer that the weight of the entirety of his purchased goods has reached a certain value.

The second means can also be used to transmit a signal to the purchasing customer if he has not properly scanned a product. This is possible because the device in accordance with the invention provides a possibility to attach a basket (container) into which the customer places his purchased products. By virtue of the second means a weight increase of the purchase is registered and by comparison with the first means it is determined whether a product has been registered the weight of which corresponds to the weight increase. This is also facilitated by the fact that the barcode, which is registered by the first means, usually also comprises the weight in encoded form. This allows to carry out a plausibility check whether or not a registered weight increase corresponds to the purchased product by direct matching the barcode registered with the first means with the weight increase registered with the second means. If this is not the case, the customer receives a respective signal e.g., optically (e.g. red light), an acoustic signal or a sensoric signal (e.g. vibration). If the matching yields the result that weight increase and registered product fit, this may be indicated to the customer with a signal (e.g. green light). To achieve this, the device in accordance with the invention may be equipped with respective means to transmit respective signals to the customer.

In accordance with a preferred embodiment, the device in accordance with the invention comprises light strips which transmit the signals in respective colors (e.g. green in case of correct and successful registration and red in case of missing or erroneous registration). By way of examples, LED light strips or light emitting diodes may be mentioned which have shown to be advantageous because of their low energy consumption.

With the third means of the device in accordance with the invention, the barcodes registered are decoded to obtain the price of the product, in case of loose goods eventually taking into account the weight, to be able to store same in the fourth means of the device according to the invention.

In accordance with a preferred embodiment, the device according to the invention may be designed in the form of a handle which allows the attachment of containers (bags) to the weighing means into which the purchased loose articles are deposited and registered with their weight. After weight registration and decoding to determine the purchase price, the bag or container containing the loose product is removed and the device is ready for registration of the next loose product, if necessary.

The device according to the invention, e.g. in the form of a handle may be manufactured in a manner known per se from a suitable polymeric material. The use of a polymeric material on one hand allows manufacture of the device with a weight as low as possible and on the other hand provides practically unlimited freedom in shape which may be adopted to the individual needs. Just by way of example, injection molding may be mentioned here; principally, however, any processing method is possible with which a shapeless starting material (e.g. granules) may be given a desired form.

In accordance with a preferred embodiment the device in accordance with the invention comprises a handle made from a polymeric material comprising
an integrated weighing function,
two or three cameras,
a display,
two LED light strips emitting red and/or green color,
a NFC chip reading device,
mobile energy supply e.g. through a rechargeable battery means for depositing the device after the shopping in a charging station forming part of a storage terminal, sensors providing a touchscreen functionality further sensors providing fingerprint identification, an anti slip-coating to avoid slip-off of the container or bag for the purchased goods.

In accordance with a further preferred embodiment the device in accordance with the invention may comprise a display on which the purchased goods with price and weight are indicated to the customer and which also optionally informs the customer immediately on the overall price for the entirety of his purchased goods. Alternatively, a respective data signal can be transmitted to a mobile receiving device through a wireless transmission method, which mobile device converts the signal with a respective app and respective software into an information concerning the purchase shown on the display of the mobile device.

For this purpose the customer may use e.g. a tablet or a mobile phone carried along. In this embodiment a display in the device according to the invention itself is not necessary. This embodiment furthermore provides the advantage that the use of mobile payment systems which have found increasing use in the recent past, becomes possible.

With the use of an app (without this being mandatory) a significant additional benefit for the customer can be achieved.

The consumer may write down or import his shopping list in the app and share same with other users. The app reminds on scheduled purchases. As an example the consumer may be reminded that a consumption product regularly needed has to be purchased anew after expiration of a certain period of time. The app may inform on product recalls which may be communicated in personalized form. Furthermore digital cashier receipts may be provided by the app and stored in same. This allows transparency on the costs of all purchases and provides the opportunity to the consumer to analyze his living costs. Furthermore, legal requirements may be fulfilled which require the mandatory compilation of a receipt without a paper printout being necessary for this purpose.

The user can define individual settings in the app related to nutritional practices and nutritional targets as well as to food allergies or food incompatibilities. Stored recipes are proposed depending on such settings and may be directly imported into the digital shopping list.

Information on the nutritional value of the recipes and its ingredients are also available. Users have the possibility to rate products or recipes. The ratings may be helpful for other customers for their decision making.

The app allows the consumer access to the history of his purchases as well as the compilation of an electronic payment receipt after a purchase.

The app may be linked to other applications—e.g. smart home applications.

Finally, the consumer may make use of individualized special offers.

These special offers may be provided to the consumer in the app individually tailored dependent on the personal settings and the use history.

Interfaces to customer cards of the individual shops allow the participation in their reward programs.

Gift certificates or meal vouchers may be scanned and registered with the device in accordance with the invention.

Through geolocalisation in the app it becomes possible to indicate to the customer suitable stores in the vicinity of his position which carry the desired products contained in his shopping list combined with information on the prices so that the consumer can make a reasoned decision where he may obtain which of his desired products at which price in which store. Thereby the customer may plan his purchases under time and cost considerations in an optimal manner.

The user may furthermore deposit his EC-cash or credit card information in the app. By doing so he may make the payment without the need to have the card itself directly available. The login in the app may be made through an account with a respective provider of payment services. Alternatively, the user may register himself manually with an e-mail address and a password. The app connects to the device according to the invention prior to each purchase through a wireless connection.

Finally, it is also possible to integrate a small display in the device according to the invention which shows a barcode or QR code which contains information to price and weight of the individual purchased goods as well as to the overall price of the entire shopping basket in encoded form. The barcode or QR code may then be registered with a camera of a mobile device such as a tablet or a mobile phone and thereafter be decoded with a suitable software to show the desired information directly to the customer.

In accordance with a preferred embodiment the device in accordance with the present invention may be combined with a so-called storage terminal to form an integrated overall system.

The terminal serves the purpose of storing and charging the devices in accordance with the invention. The terminal may be positioned in each entrance and leaving area of a store. When entering the store, the customer picks up a device in accordance with the invention (e.g. a handle) from the terminal and when leaving he puts back the device into the terminal. Furthermore the terminal may be equipped with a display and a cash receipt printer. The customer can print invoice receipts or may obtain information relating to the system with the device in accordance with the invention. The system is preferably designed in such a manner that the successful completion of his shopping requires re-attachment of the device to the terminal. If the device is not re-attached, a warning signal is produced at the handle. Thereby thefts of articles as well as thefts of the handles can be prevented.

In addition the terminal may comprise a device for shopping bags or containers which are tailored to the device in accordance with the invention. The customer may purchase such bags or containers against a one-time payment and may re-use same in subsequent shoppings which is also desirable under ecological aspects. As he can take the shopping bag or shopping container with him once he has purchased same any effort for re-packing of purchased goods can be avoided. The shopping bag or shopping container may comprise several compartments or dividing elements which allows a sorting of the purchased goods already at the time of purchase which facilitates dispelling and storing the purchased goods at home. The shopping bag or container may comprise thermally isolated compartments in which temperature sensitive products may be safely transported home while protected against deterioriation. The device in accordance with the invention may be connected to the terminal through a secure connection and may thus serve as interface to payment providers and the app.

Finally, the terminal may also serve the puropose to monitor the status of charge of the device in accordance with the invention. If a customer picks up a device with a status of charge too low this may be signaled to him to avoid problems because of failure of the energy supply during his shopping.

The figures show the principal construction of a device in accordance with the invention.

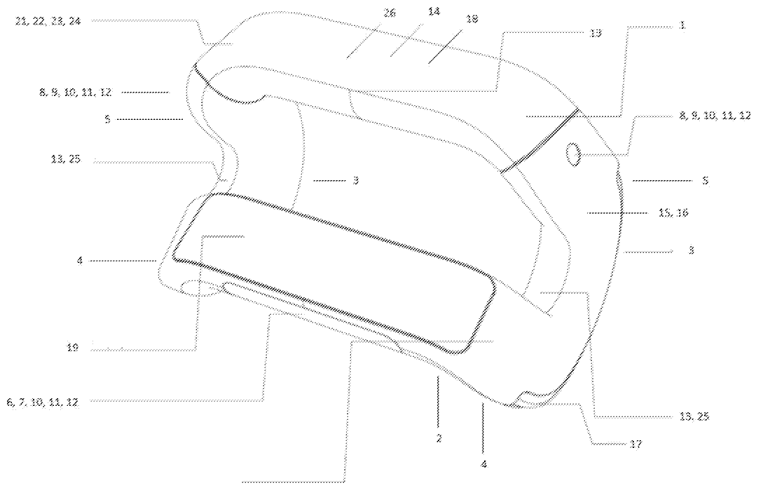

FIG. 1 shows an exemplary device in the form of a carrying handle.

The device is designed as a carrying handle comprising a handle piece 1, a connecting piece 2 oriented in a parallel manner to the handle piece 1 and one, preferably two hook-shaped hang-in elements 3 comprising a shorter terminal piece 4 and a longer terminal piece 5 with the hook-shaped hang-in elements 3 oriented, in particular nearly, parallel to each other and connected to the connecting piece 2 through the shorter terminal piece and connected to the handle piece 1 through the longer terminal piece 5.

The hang-in elements 3 are equipped with an anti-slip coating 25.

The first means in accordance with a preferred embodiment comprises at least one first camera 6 and/or a first barcode-scanner 7, preferably a first and second camera 8 and/or barcode-scanner 9 with the first camera 6 or the first barcode scanner 7 being mounted at the connecting piece 2 preferably on the side opposite to the handle piece 1 and the second camera 8 or the second barcode scanner 9 being mounted at one of the hang-in elements 3 on the side opposite to the second hang-in element 3. The first means in accordance with a preferred embodiment comprises in particular two LED lights 10 which, through the overlap point of their light cones mark the recordation point of the first camera 6 and/or the second camera 8 and/or the first and second barcode scanners (7,9). Furthermore, a distance sensor 11 and/or a movement sensor 12 are present.

The second means 13 for registration (determination) of the weight is positioned preferably at the handle piece 1 and/or where the shopping bag or shopping container 27 is attached and is preferably designed as 3D force sensor, with two 3D force sensors being preferred, one respectively at each hang-in element or in the vicinity of the support point of the attached shopping bag or shopping container 27.

The handle piece, in accordance with a preferred embodiment comprises at least one 9G-sensor 14, in particular a gyroscope and/or at least one acceleration sensor and is in active connection with the second means for registration (determination) of the weight.

The third means for decoding 15 of the registered barcodes or QR codes and the fourth means for storing 16 are preferably designed as microcontrollers.

Furthermore, the handle piece 1 preferably comprises a handle section 26 mounted (suspended) movably in relation to the handle piece 1.

In accordance with a further preferred embodiment the device comprises lighting means 17 which may shine in n different colors, with n=1, 2, 3, 4, 5, 6, 7, 8, 9 or more and the handle piece 1 preferably comprises a vibration means 18.

Lighting means 17 and vibration means 18 are designed to indicate activities and their status during shopping and to be in active connection with first means for recognition and scanning of barcodes or QR codes and with second means for weight determination.

In accordance with a further preferred embodiment a display 19 is positioned in particular on the side of the connecting piece 2 facing the handle piece 1 and is in active connection with fourth means 16 for storage of price and number and is preferably designed as touchscreen.

Furthermore, the device preferably comprises a NFC chip reading device 20 and/or a WLAN module 21 and/or a mobile communication module 22 to communicate eventually with a payment service and/or a computer network.

In accordance with a further preferred embodiment the device comprises a mobile energy supply 23, in particular a rechargeable battery.

The device preferably also comprises a fingerprint sensor 24 for authentification of a user.

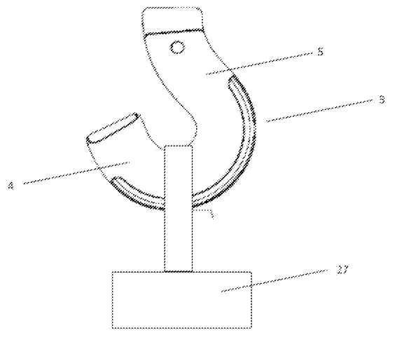

FIG. 2 shows a device in accordance with the invention with a shopping bag or shopping container 27.

From the foregoing it becomes apparent that the device in accordance with the invention, optionally in combination with an app, provides multiple advantages facilitating shopping and payment for the customer thereby providing time savings and which give the opportunity to the shop to provide a faster and convenient shopping experience to the customer without the need of significant modifications of his existing setup.

### LIST OF REFERENCE NUMERALS

1. Handle piece 1
2. Connecting piece 2
3. Hook-shaped hang-in element 3
4. Shorter terminal element 4
5. Longer terminal element 5
6. First camera 6
7. First barcode scanner 7
8. Second camera 8
9. Second barcode scanner 9
10. LED light strips 10
11. Distance sensor 11
12. Movement sensor 12
13. Means for determining weight 13
14. 9G Sensor 14
15. Third means for decoding 15
16. Fourth means for storingl6
17. Lighting element 17
18. Vibration element 18
19. Display 19
20. NFC-Chip reading device 20
21. W-LAN module 21
22. Mobile communication module 22
23. Mobile energy supply 23
24. Fingerprint sensor 24
25. Anti-slip coating 25
26. Movably supported handle section 26
27. Shopping bag 27

1. Device for use as shopping and payment system for goods of any kind comprising
first means for registering and scanning of barcode-symbols second means (13) for determining and registering the weight of a purchased article
third means (15) for decoding the registered barcodes to register the price of the purchased articles in a digital product basket, and fourth means (16) for storing price and, if applicable, number or weight of the individual purchased articles.

2. Device in accordance with claim 1 designed as carrying handle comprising a handle piece (1), a connecting piece (2) oriented in a parallel manner to the handle piece (1) and one, preferably two hook-shaped hang-in elements (3) comprising a shorter terminal piece (4) and a longer terminal piece (5) with the hook-shaped hang-in elements (3) oriented, in particular nearly, parallel to each other and connected to the connecting piece (2) through the shorter terminal piece (4) and connected to the handle piece (1) through the longer terminal piece (5).

3. Device in accordance with claim 1 or 2 wherein the first means comprises at least one first camera and/or a first barcode-scanner, preferably a first and second camera and/or barcode-scanner with the first camera or the first barcode scanner being mounted at the connecting piece (2) preferably on the side opposite to the handle piece (1) and the second camera or the second barcode scanner being mounted at one of the hang-in elements on the side opposite to the second hang-in element.

4. Device in accordance with claim 3 with first means comprising in a preferred embodiment in particular two LED lighting elements which, through the overlap point of their light cones mark the recordation point of the first camera and/or the second camera and/or the first and second barcode scanners (7,9).

5. Device in accordance with claim 3 or claim 4 comprising, in a preferred embodiment, a distance sensor (11) and /or a movement sensor (12) designed to control switch on or off the first means.

6. Device in accordance with any of the preceding claims wherein the second means (13) for determination of the weight is attached at the handle piece (1) or at the position where the shopping bag or shopping container is positioned.

7. Device in accordance with any of the preceding claims wherein the second means for registration of the weight is preferably a 3D-force sensor, in particular two 3D force sensors are present preferably one at each supporting point, or in the vicinity thereof, of the attached shopping bag or shopping container of the two hook-shaped hang-in elements (3).

8. Device in accordance with any of the preceding claims wherein the device, in particular the handle piece (1) comprises at least one 9G sensor (14) comprising in particular a gyroscope and/or at least one movement sensor which is in active connection with the second means (13) for registration and determination of the weight.

9. Device in accordance with any of the preceding claims comprising third means (15) for decoding of the registered barcodes and fourth means (16) for storing which are preferably designed as microcontrollers.

10. Device in accordance with any of the preceding claims wherein the handle piece (1) comprises a handle section (26) movably supported relative to the handle piece (1).

11. Device in accordance with the preceding claims comprising one or more lighting elements (17) shining in n different colors with n being 1, 2, 3, 4, 5, 6, 7, 8, 9 or more and/or wherein the handle piece (1) comprises a vibration element (18) wherein lighting elements (17) and vibration element (18) are designed to represent activities during shopping and their status and are in active connection with first means for registration and scanning of barcodes and second means (13) for registration and determination of the weight.

12. Device in accordance with any one of the preceding claims comprising, in a preferred embodiment, a display (19) positioned in particular on the side of the connecting piece (2) facing the handle piece (1) and being in active connection with a fourth device (16) for storing price and, if applicable, number of purchased goods, preferably designed as touch screen.

13. Device in accordance with one of the preceding claims comprising, in a preferred embodiment, a NFC reading device (20), a WLAN module (21) or a mobile communication module (22).

14. Device in accordance with one of the preceding claims comprising a mobile energy supply device (23), in particular a rechargeable battery.

15. Device in accordance with one of the preceding claims comprising a fingerprint sensor (24) for authentification of a user.

16. Device in accordance with any of the preceding claims wherein the hang-in elements (3) are provided with an anti-slip coating (25).
